(19) United States
(12) Patent Application Publication
(10) Pub. No.: US 2012/0192384 A1
(43) Pub. Date: Aug. 2, 2012

(54) Adjustable Utility Strap

(76) Inventor: Rayanne Kelly, Cocoa Beach, FL (US)

(21) Appl. No.: 13/017,305

(22) Filed: Jan. 31, 2011

(51) Int. Cl. B65D 63/00; F16B 2/20; F16B 2/02; A44B 18/00; A44B 17/00; A44B 11/25

(52) U.S. Cl. 24/302

(57) ABSTRACT

An adjustable utility strap is disclosed. The strap includes a free first end and a second end. A loop is formed from the second end of the strap and folded back on itself. A buckle is threaded through the first end of the strap and the second end of the strap is secured to the buckle using the loop. A clamping assembly is threaded through the first end of the strap between the buckle and the loop, where a length between a first snap and the clamping assembly is adjusted by pulling the first end of the strap through the buckle. The buckle has a first slot and a second slot that form an intermediate strut, where the loop is secured to the strut of the buckle. The clamping assembly further includes a slot to allow the strap to slide therethrough as the length of the strap is adjusted.

### I. FIELD

The present disclosure is generally related to an adjustable utility strap.

### II. DESCRIPTION OF RELATED ART

A typical bowrider recreational boat includes male snap portions that are used to secure canvas covers having the female snap portions. The snaps are usually mounted around the perimeter of the seating portion of the bow of the boat. Often times a passenger will sit in the bow portion of the boat and use a towel against the seating backrest for increased comfort. However, each time the passenger leans forward the towel is likely to slip down and when the passenger leans back and the passenger will then contact the seating backrest directly. Accordingly, there is a need for a utility strap that restrains the towel in the desired position in the seating area of a bowrider boat.

In addition, the bow of the boat receives the brunt of the wind force as the boat travels at high speeds. Accordingly, anything not secured in the bow is susceptible to being blown out of the boat causing a flying hazard and also loss of personal property. Accordingly, there is also a need to restrain objects within the boat when traveling.

However, in view of the prior art at the time the present invention was made, it was not obvious to those of ordinary skill in the pertinent art how the identified needs could be fulfilled.

### IV. SUMMARY

In a particular embodiment, an adjustable utility strap is disclosed. The strap includes a free first end and a second end, a first snap proximate to the first end of the strap, a loop formed from the second end of the strap folded back on itself, a buckle threaded through the first end of the strap and the second end of the strap secured to the buckle using the loop, and a clamping assembly threaded through the first end of the strap between the buckle and the loop, where a length between the first snap and the clamping assembly is adjusted by pulling the first end of the strap through the buckle. The first snap is adapted to engage an opposite portion of a mounted snap on a fixed surface and the buckle has a first slot and a second slot that form an intermediate strut, where the loop is secured to the strut of the buckle. In addition, the first end of the strap is threaded up through the first slot over the intermediate strut and back down through the second slot and the clamping assembly further includes a slot to allow the strap to slide therethrough as the length of the strap is adjusted. The strap may include a second snap disposed between the first snap and the buckle, where the second snap is adapted to engage the first snap to form a loop section from the first end of the strap. The second snap may include a male portion on a first side of the strap and a female portion on the second side of the strap so that two straps may be secured together.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

For a fuller understanding of the nature and objects of the invention, reference should be made to the following detailed description, taken in connection with the accompanying drawings, in which:

FIG. 1 is a front view of a particular illustrative embodiment of an adjustable utility strap;

FIG. 2 is a rear view of the adjustable utility strap;

FIG. 3 is a side view of the adjustable utility strap;

FIG. 4 is a perspective view of an example of a boat that may be used with the adjustable utility strap;

FIG. 5 is a perspective view of the adjustable utility strap shown secured to a boat snap and a towel;

FIG. 6 is a perspective view of the two adjustable utility straps secured together; and

FIG. 7 is a side view of the adjustable utility strap secured to a boat rail.

### VI. DETAILED DESCRIPTION

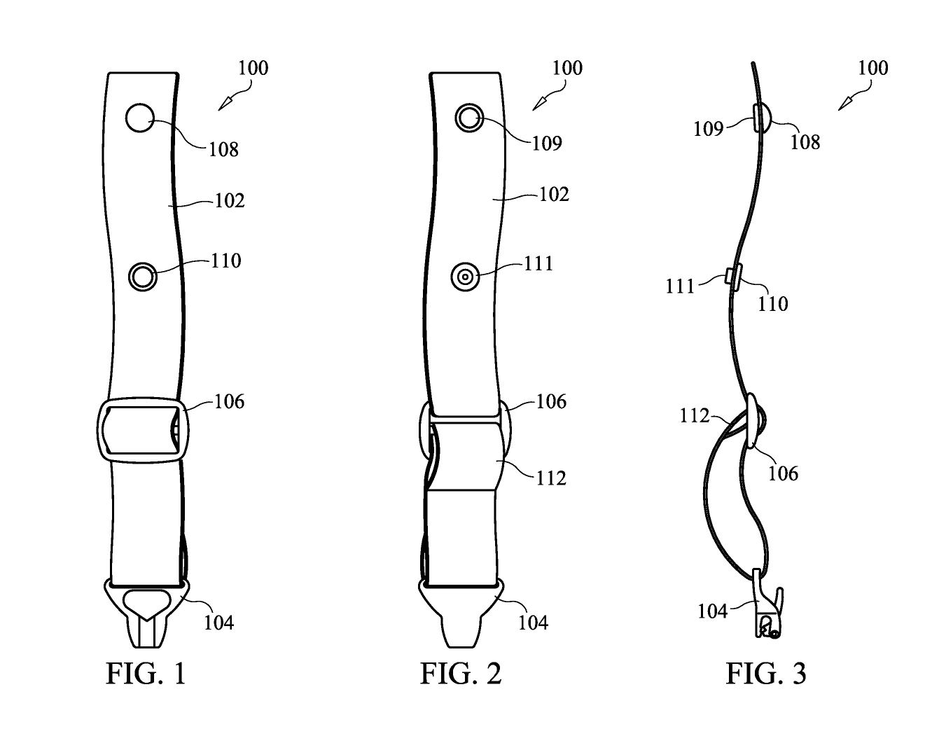

Referring now to FIGS. 1-3, an adjustable utility strap is generally designated 100.

The strap 102 includes a free first end and a second end. A first snap 108 is proximate to the first end of the strap 102. A loop 112 is formed from the second end of the strap 102 folded back on itself best illustrated in FIG. 3. A buckle 106 is threaded through the first end of the strap 102 and the second end of the strap 102 is secured to the buckle 106 using the loop 112. A clamping assembly 104 is threaded through the first end of the strap 102 between the buckle 106 and the loop 112, where a length between the first snap 108 and the clamping assembly 104 is adjusted by pulling the first end of the strap 102 through the buckle 106.

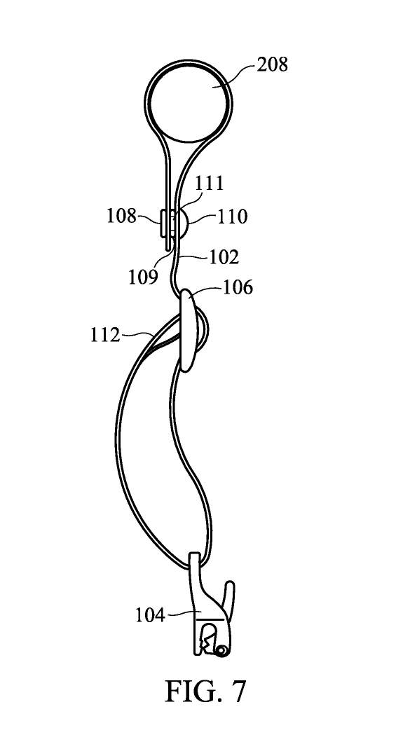

The buckle 106 has a first slot and a second slot that form an intermediate strut, where the loop 112 is secured to the strut of the buckle 106. The first end of the strap 102 is threaded up through the first slot over the intermediate strut and back down through the second slot of the buckle 106. The clamping assembly 104 further includes a slot to allow the strap 102 to slide therethrough as the length of the strap 102 is adjusted. A second snap 110 may be disposed between the first snap 108 and the buckle 106, where the second snap 110 is adapted to engage the first snap 108 to form a loop section from the first end of the strap 102, as illustrated in FIG. 7.

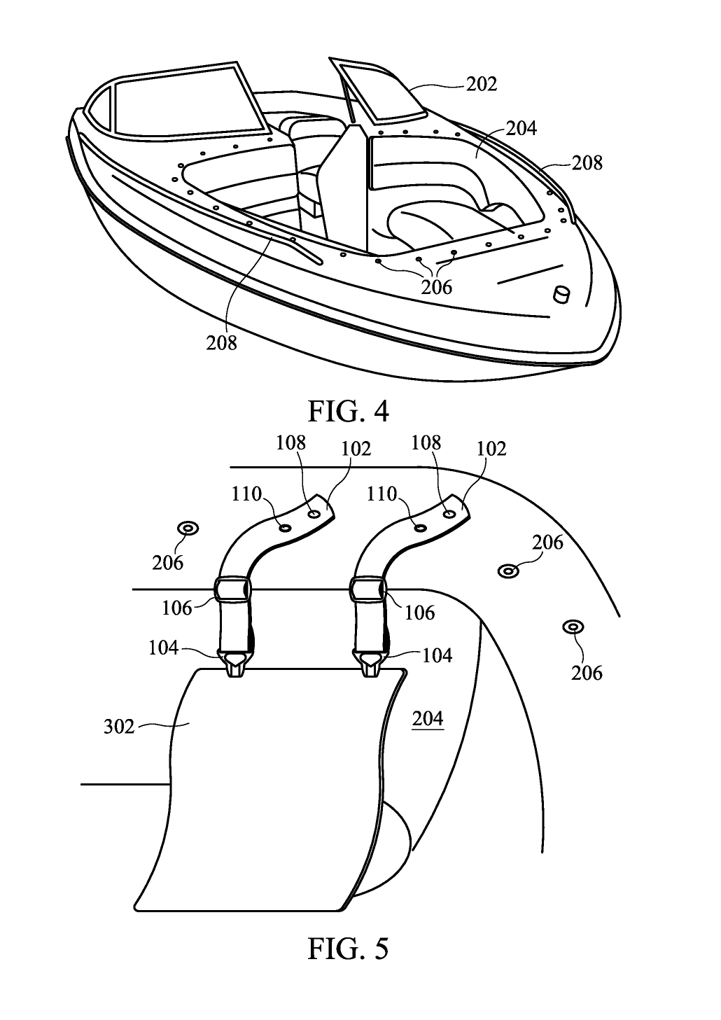

The second snap 110 further includes a male portion on a first side of the strap 102 and a female portion on the second side of the strap 102. The first snap 108 is adapted to engage an opposite portion of a mounted boat snap 206 on a fixed surface such as a boat 202, as illustrated in FIGS. 4 and 5. For example, a pair of straps 100 may be used to each hold a corner of a towel 302 up over a boat seat backrest 204. The adjustable strap 100 prevents the towel 302 from slipping down or from inadvertently flying out of the boat when moving or from a gust of wind.

In this example, the first snap 108 of each strap 100 is secured to a respective boat snap 206. The length of the strap 100 is adjusted using the respective buckle 106. The clamping mechanism 104 is removably secured to the towel 302 so that the towel 302 is positioned in the desired location. Alternatively, the strap 100 may be folded over itself and snaps 108 to 110 securing the strap 100 around sandals, for example, to prevent the sandals from blowing out of the boat. The strap 100 can be secured to existing male snap portions included on a boat to attach optional carpeting.

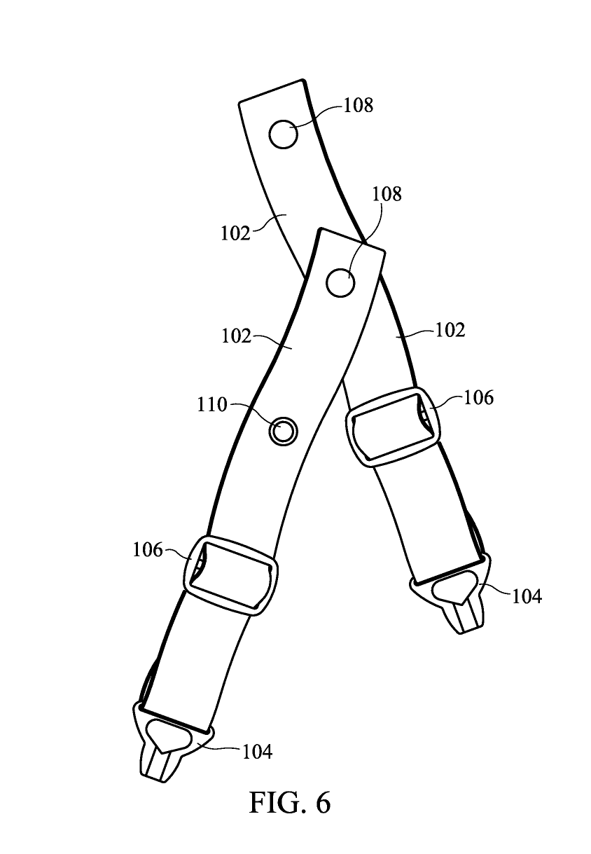

The adjustable utility strap 100 may also include a second strap as illustrated in FIG. 6. Accordingly, the second snap 110 of the strap 100 may further include a male portion on a first side of the strap 102 and a female portion on the second side of the strap 102. The second strap may be secured to the first strap using the second snap 110 of the first strap to the first snap 108 of the second strap. Thus, a single boat snap 206 can be used to secure the utility strap 100 and secure to a towel with two clamping mechanisms.

Referring now to FIG. 7, the adjustable utility strap 100 is also configured to allow the strap 102 to secure around a boat rail 208 and the second snap 110 to connect to the first snap 108.

The adjustment means 106 of the adjustable utility strap 100 may be a buckle. Alternatively, the adjustment means 106 may include hook and loop fastener. In the preferred embodiment the strap 102 is comprised of a nylon webbing material. Alternatively, the strap 102 is comprised of polypropylene material. The clamping assembly 104 of the adjustable utility strap 100 may include a butterfly clip or a spring loaded clip that is easy to secure and to remove items with an approximate thickness of a towel. The clamping assembly 104 may be comprised of polypropylene material or other corrosion resistive material such as stainless steel. The adjustment means 106 may likewise be comprised of polypropylene material or other corrosion resistive material. The first and second snaps may be comprised of a polypropylene material or other corrosion resistive material such as stainless steel. The strap may be comprised of an elastic material.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An adjustable utility strap, the strap comprising:
a strap having a free first end and a second end;
a first snap proximate to the first end of the strap;
a loop formed from the second end of the strap folded back on itself;
a buckle threaded through the first end of the strap and the second end of the strap secured to the buckle using the loop; and
a clamping assembly threaded through the first end of the strap between the buckle and the loop, wherein a length between the first snap and the clamping assembly is adjusted by pulling the first end of the strap through the buckle.

2. The adjustable utility strap of claim 1, wherein the first snap is adapted to engage an opposite portion of a mounted snap on a fixed surface.

3. The adjustable utility strap of claim 2, wherein the buckle has a first slot and a second slot that form an intermediate strut, wherein the loop is secured to the strut of the buckle.

4. The adjustable utility strap of claim 3, wherein the first end of the strap is threaded up through the first slot over the intermediate strut and back down through the second slot.

5. The adjustable utility strap of claim 4, wherein the clamping assembly further comprising a slot to allow the strap to slide therethrough as the length of the strap is adjusted.

6. The adjustable utility strap of claim 5, further comprising a second snap disposed between the first snap and the buckle, wherein the second snap is adapted to engage the first snap to form a loop section from the first end of the strap.

7. The adjustable utility strap of claim 6, wherein the second snap further comprising a male portion on a first side of the strap and a female portion on the second side of the strap.

8. The adjustable utility strap of claim 7, further comprising a second strap, the second strap comprising:
a third snap proximate to a first end of the second strap;
a second loop formed from a second end of the second strap folded back on itself;
a second buckle threaded through the first end of the second strap and the second end of the second strap secured to the second buckle using the second loop; and
a second clamping assembly threaded through the first end of the second strap between the second buckle and the second loop, wherein a length between the third snap and the second clamping assembly is adjusted by pulling the first end of the second strap through the second buckle.

9. An adjustable utility strap, the strap comprising:
a strap having a free first end and a second end;
a first snap proximate to the first end of the strap;
a second snap disposed along a length of the strap and configured to allow the strap to secure around a boat rail and the second snap to connect to the first snap;
an adjustment means to adjust a length of the strap; and
a clamping assembly disposed proximate the second end.

10. The adjustable utility strap of claim 9, wherein the adjustment means is a buckle.

11. The adjustable utility strap of claim 9, wherein the adjustment means is a hook and loop fastener.

12. The adjustable utility strap of claim 9, wherein the strap is comprised of a nylon webbing material.

13. The adjustable utility strap of claim 9, wherein the strap is comprised of polypropylene material.

14. The adjustable utility strap of claim 9, wherein the clamping assembly comprises a butterfly clip.

15. The adjustable utility strap of claim 9, wherein the clamping assembly is comprised of polypropylene material or noncorrosive metal.

16. The adjustable utility strap of claim 9, wherein the adjustment means is comprised of polypropylene material or noncorrosive metal.

17. The adjustable utility strap of claim 9, wherein first and second snaps are comprised of a polypropylene material or noncorrosive metal.

18. The adjustable utility strap of claim 9, wherein the second snap further comprising a male portion on a first side of the strap and a female portion on the second side of the strap.

19. The adjustable utility strap of claim 9, wherein the strap further is comprised an elastic material.

20. The adjustable utility strap of claim 9, further comprising a second strap adapted to secure to the strap using the second snap.
